(19) United States
(12) Patent Application Publication
(10) Pub. No.: US 2018/0202719 A1
(43) Pub. Date: Jul. 19, 2018

(54) System and method for dynamic process modeling, error correction and control of a reheat furnace

(71) Applicants: Richard W. Vesel, JR., Hudson, OH (US); Sivashanmugam Alagarsamy, Solon, OH (US); Brad J. Radl, Chardon, OH (US)

(72) Inventors: Richard W. Vesel, JR., Hudson, OH (US); Sivashanmugam Alagarsamy, Solon, OH (US); Brad J. Radl, Chardon, OH (US)

(73) Assignee: Griffin Open Systems, LLC, Chardon, OH (US)

(21) Appl. No.: 15/410,678

(22) Filed: Jan. 19, 2017

(51) Int. Cl. F27D 19/00

(52) U.S. Cl. CPC F27D 19/00; F27D 2019/0065; F27D 2019/0003

(57) ABSTRACT

A system and method for controlling the temperature setpoints in a furnace such that a random mixture of slabs with different compositions, sizes, initial temperatures, temperature requirements, and anticipated residence times are all discharged at an appropriate temperature, with emphasis upon ensuring that no slab is insufficiently heated (rejected) per rolling and quality requirements. This is to be accomplished with minimized fuel use. This system can be implemented in a graphical programming environment, where real-time tuning, configuration, logic changes, model replacement, model retraining and other programming changes can be made without interruption of control.

### BACKGROUND

### Field of the Invention

The present invention relates generally to controlling large-scale reheat furnaces, and in particular to a system and method for controlling temperature setpoints and regulating slab extraction from a multi-zone steel reheat furnace.

### Description of the Prior Art

Steel reheat furnaces, particularly walking beam furnaces, are typically divided into multiple zones along their length where the temperatures in each zone are controlled by one or more burners located in the zones. When multiple burners exist in a given zone, it is possible that fuel flow through each burner may be controlled individually giving independent side to side and/or top to bottom temperature control. Steel slabs are loaded from a charge side and traverse through the furnace over a period of time until they are extracted at which point they enter the rolling mill. Heat rate is the average amount of heat available from the heating source (e.g. natural gas) consumed per ton of steel produced. While heat rate is affected by a number of factors, including desired temperature, heat capacity of the particular type of steel and the like. The goal of the process is to maximize the heat into each slab and minimize the heat lost.

Modern reheat furnace control systems typically include a computer model of the slab temperature distribution for each slab inside the furnace normally controlled by temperature measurements for point locations on the furnace walls and ceiling. (See “On the Thermal Behavior of the Slab in a Reheating Furnace with Radiation” by Lee and Kim). This model may be as simple as one-dimensional heat transfer through the slab thickness, or the entire furnace may be modeled. Regardless of the complexity of the model, the model is used to estimate slab temperatures as they pass through the furnace. Feedback to the model is often provided via slab temperature measurements that occur post-discharge from the furnace and/or after the slab has exited the roughing mill.

There are multiple primary objectives in controlling temperatures in reheat furnaces. One is to ensure that the steel slabs are heated such that the measured steel temperature at a certain point in the rolling, usually after the roughing stage (referred to as the “rougher exit temperature”), is within an appropriate window. If it is too hot, the steel may have excessive slagging or surface melting; if too cold, increased rolling power is required, and slabs may be rejected as the desired metallurgical properties are not obtained. There may be statistical rules governing the number of temperature measurements allowable at a certain level below nominal before a slab is rejected.

A second objective is to create an appropriate temperature distribution through the steel slab by the time it is extracted from the furnace, both through the slab and across the length of the slab. This ensures that the core of the slab is sufficiently heated, and a proper temperature difference exists between the top and bottom slab surfaces in order to prevent the slab curling up or down while being rolled.

A third objective is to accomplish the prior two stated objectives with minimum energy input into the furnace, and when possible, minimizing slab residence time in the furnace. There are additional objectives to furnace control such as ensuring internal furnace temperatures do not exceed safe levels or shorten the life of the furnace and burners.

Several control schemes have been proposed for determining the furnace temperatures which result in sufficient slab heating as well as minimal fuel use. U.S. Pat. Nos. 4,255,133 and 4,501,552 describe analytical methods of determining ideal temperature setpoints by considering the overall heat balance of the slabs and furnace. U.S. Pat. No. 4,606,529 describes a method of updating setpoints calculated by the aforementioned method by measuring the actual slab heating progress in the furnace and adjusting the anticipated slab heating profiles and temperature setpoints accordingly. Most reheat furnaces, however, are not equipped to reliably measure slab temperatures inside the furnace. Additionally, the prior art methods optimize temperatures for each slab independently. Thus, it is possible for conflicting temperature patterns to be produced, which can result in wasted heat and slab rejects.

One complication that arises when operating a reheat furnace is variability in the operating conditions of the rolling mill operations and other facets (e.g. slab loading, scheduling) of the production line which affect the rate at which slabs can be extracted from the furnace(s). U.S. Pat. No. 4,373,364 discusses a method to recalculate slab heating profiles based on revised residence times due to changes in the mill processing rate in tons per hour. The method can also incorporate the effects of other production delays, such as unexpected rolling suspensions (holds) of varying duration. When the anticipated duration is known, the method recalculates a slab heating profile with a longer period such that the current slab temperature intersects with the correct point on the revised heating profile such that the time until slab readiness matches the revised expected discharge time of the slab. However, in reality, after short holds, slabs may be extracted in rapid succession in order to take advantage of the extra heating time. Furthermore, this method is not ideal for fuel savings in the case of long holds, and does not account for holds of unknown duration. It would be advantageous to have improvements in both of these areas, with concurrent benefits of improved heat rate and lower rejection rate.

A second complication arises when furnaces are charged with a mix of slabs, which can vary in size, weight, composition, and temperature requirement. U.S. Pat. No. 5,006,061 describes a method of identifying a virtual slab in each zone of the furnace, which represents a combination of the slabs presently in that zone. Temperatures are then controlled to adequately heat the virtual slab while minimizing fuel use, although the patent does not describe how to select those temperatures nor how to correct for errors in the virtual slab temperature estimates.

Further complications include variable burner performance and air and fuel mix distribution. Slab placement within the furnace affects the side to side temperature profile of a slab, which will result in poor head to tail temperature profiles on furnace exit, even when the average enthalpy and heat content of the slab are correct. Error correction and fuel usage optimization must accommodate these changes, while recognizing the limitations of current firing conditions.

A limitation in U.S. Pat. Nos. 4,255,133 and 4,501,552 is the method of selecting temperatures are based on a heat balance analysis of the entire furnace, and accuracy of these methods requires precisely knowing several coefficients describing the furnace's thermal characteristics, such as how much heat is escapes through exhaust and other losses (stack losses, heat of input gas etc.). In reality, the state of furnace maintenance is highly variable, and it is difficult to measure how much heat is lost through charge and extraction doors, as well as from all other areas of the furnace, which highly depends on the state of upkeep of the furnace structure and insulation (which in turn create a dynamics in the heat loss terms) These methods also have a difficult time accounting for the varying rates at which heat is absorbed by different sizes and types of slabs, including the temperature distribution within the slab, in order to ensure that a mix of slabs are discharged with each having a minimum temperature error. The virtual slab method described in U.S. Pat. No. 5,006,061 addresses heating a mix of material, but does not give guidance on the actual temperature selection. Additional challenges are centered around knowing the heat input, where inaccuracies in the measurement of air and gas flows impact the energy input, and measurement of non-combusted gas (CH4) and other partial reactions such as CO are not measured or only measured sparingly and are not fully representative of the actual heat released.

Another important consideration in furnace control is making adjustments to the planned temperature setpoints in order to account for the real error observed between the desired slab temperatures and the measured ones. This is important both for quality control and to prevent wasting heat (i.e. heat rate performance). U.S. Pat. No. 5,873,959 describes a method for tracking and filtering the ratio between the calculated discharge temperatures and the rougher exit temperatures for different types of material, as well as the error between measured and desired slab temperatures. The aim discharge temperature for slabs entering the furnace is calculated using this information. It would be advantageous to use a similar method, but the relationship between the calculated discharge and rougher exit temperatures is predicted by a neural network which may be static or may be retrained in real-time.

A compounding problem is that the actual temperature measurement of the slab surface will have its own non-reproducible errors, which may arise from gravel on the surface of a slab, slag build-up on the surface, debris on the sensor, etc. It would be advantageous for data filtering can be applied to the slab surface temperature measurements in order to minimize the impact of erratic or erroneous measurements.

In the operation of a reheat furnace, a substantial amount of the steel in the slab is lost due to surface oxidization while in the furnace. Excess combustion air also results in potential cooling of the slabs, and requires extra fuel just to heat the additional air, and extra electricity to power the fans providing the air. These effects can be mitigated by minimizing furnace temperatures and by reducing excess combustion air.

Finally, modern furnace control systems should be customizable and accessible for the user, so that they may best adapt the system to their needs. It should also provide displays providing important status and performance information. U.S. Pat. No. 4,975,865 describes a general digital processing system for monitoring, controlling, and simulating industrial processes, wherein graphical displays are made available to the user. However, this does not guarantee customizability of the underlying control by users, especially users without programming expertise. The current embodiment is therefore implemented in a graphical programming environment, as described in U.S. Pat. No. 9,058,029. In this system, a simple drag and drop interface is used to build the control logic, and many prepackaged tools are made available to the user, including many types of control flow, genetic optimization, and neural networks. In addition, real-time refresh functionality allows the user to implement logic and model changes on the fly without any interruption of the process or process control.

### SUMMARY OF THE INVENTION

It is an object of the present invention to provide a method for controlling the temperature setpoints in a furnace such that a random mixture of slabs with different compositions, sizes, initial temperatures, temperature requirements, and anticipated residence times are all discharged at an appropriate temperature, with emphasis upon ensuring that no slab is insufficiently heated (rejected) per rolling and quality requirements. This is to be accomplished with minimized fuel use. It is a further object of the present invention to implement this system in a graphical programming environment, where real-time tuning, configuration, logic changes, model replacement, model retraining and other programming changes can be made without interruption of control.

The present invention pertains to systems where a heat model of each slab is employed. The current computed temperature for a slab at the time when it is extracted from the furnace will be referred to as the “calculated discharge temperature.” The target value of this temperature for a given slab, as determined by the control logic, will be referred to as the “aim discharge temperature.” The difference between the calculated discharge temperature and the measured slab temperature will be referred to as “temperature loss.”

In addition to the prevention of melting on the slab surface. The present invention deals with the three objectives of sufficient slab temperature, appropriate slab temperature distribution, and minimal fuel use all within the constraints of the furnace and desired production temperature expectations.

The procedure used for selecting temperature setpoints for the zones and sub-zones (top and bottom) of a furnace involves multiple simulation trials of each slab passing through the furnace, followed by neural network based temperature loss estimation. The chosen setpoints are obtained by interpolating between predetermined (initial) sets of allowable temperature setpoints, chosen to minimize fuel use and provide an adequate temperature distribution of discharged slabs at different temperature levels spanning the operating range of the furnace. The process is continually repeated as the slabs move the furnace and are inserted or extracted.

The furnace is then controlled such that the slabs with the highest necessary temperature setpoints are adequately heated. Periodic recalculation of ideal setpoints for slabs passing through the furnace ensures that the appropriate changes are made in response to the actual slab temperature rises filtered for extraneous readings, and changes in extraction rates due to mill conditions or production delays. Error between measured (and filtered) slab temperatures and the expected temperatures from the neural network is achieved by tracking and filtering the error in predictions and applying an appropriate bias to future temperature loss predictions. The time until the next-to-extract slab is adequately heated is continuously calculated, and this value is fed into the mill control system preventing potential rejection of under heated or unevenly heated slabs.

To minimize slagging, the excess oxygen is reduced to levels sufficient to combust the total fuel. The constraint is the level of CO, especially near the exit of the furnace before the gas exits up the stack. Additionally, the air control logic can be tuned to respond to burner issues or temperature gradient problems with steel slabs measurement on exit.

Special handling of long production delays is used in order to bring slabs nearing extract up to their aim discharge temperature upon resumption of production while minimizing fuel usage by drastically cutting temperature setpoints. A default delay is used unless a manual or automatic expected delay value is entered. The time needed to raise temperatures and prepare slabs for discharge is continuously estimated, allowing the furnace to increase temperatures in a timely manner.

The present invention can be implemented in a graphical programming environment, where displays are used both to modify program configuration and to make actual logic changes, both of which can be updated in real time without interruption control. A graphical feature unique to the current embodiment is a display of the furnace that provides the user information about the slab positions and estimated temperatures, and also each slab's relative progress toward discharge temperature.

### DESCRIPTION OF THE FIGURES

Attention is now directed to several drawings the illustrate features of the present invention.

FIG. 1 shows a top-down view of a steel reheat furnace populated with slabs. The zone divisions are marked.

FIG. 2 shows a table describing the zone and top/bottom placement of each burner in the furnace.

FIG. 3 shows potentially conflicting optimized setpoints for different slabs.

FIG. 4 shows a diagram of the interpolation of two groups of setpoints.

FIG. 5 shows many setpoint combinations as the result of different optimizations, and the final selected parent setpoint group.

FIG. 6 shows the process for selecting temperature setpoints for a slab.

FIG. 7 shows the graphical furnace map combined with relative readiness display.

FIG. 8 shows a table giving sample setpoints for several slabs in the vicinity of burner #7.

FIG. 9 shows an example of CO increase as air-to-fuel ratio is decreased.

FIG. 10 shows an example of several sequential temperature loss model error calculations, along with the filtered error values.

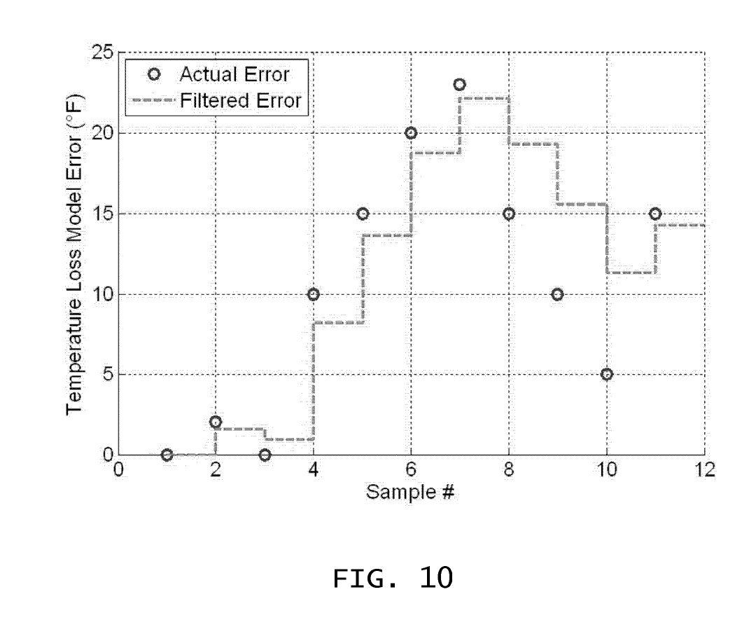

FIG. 11 shows a diagram of the principle components of the furnace control system.

FIG. 12 shows an alternative assembly, where the air control element has been moved inside the burner PLC.

Several figures and illustrations have been provided to aid in understanding the present invention. The scope of the present invention is not limited to what is shown in the figures.

### DESCRIPTION OF THE PREFERRED EMBODIMENTS

The present invention provides a system and method for controlling the temperature setpoints in a large scale steel reheat furnace such that a wide variety (even random) mixture of slabs with different compositions, sizes, initial temperatures, temperature requirements, and anticipated residence times are all discharged at an appropriate temperature with emphasis on ensuring that no slab is insufficiently heated per rolling and quality requirements. This is accomplished with minimized fuel use per ton of steel produced. The present invention combines this system with a graphical user interface where real-time configuration and programming changes can be made without interrupting the process or process control.

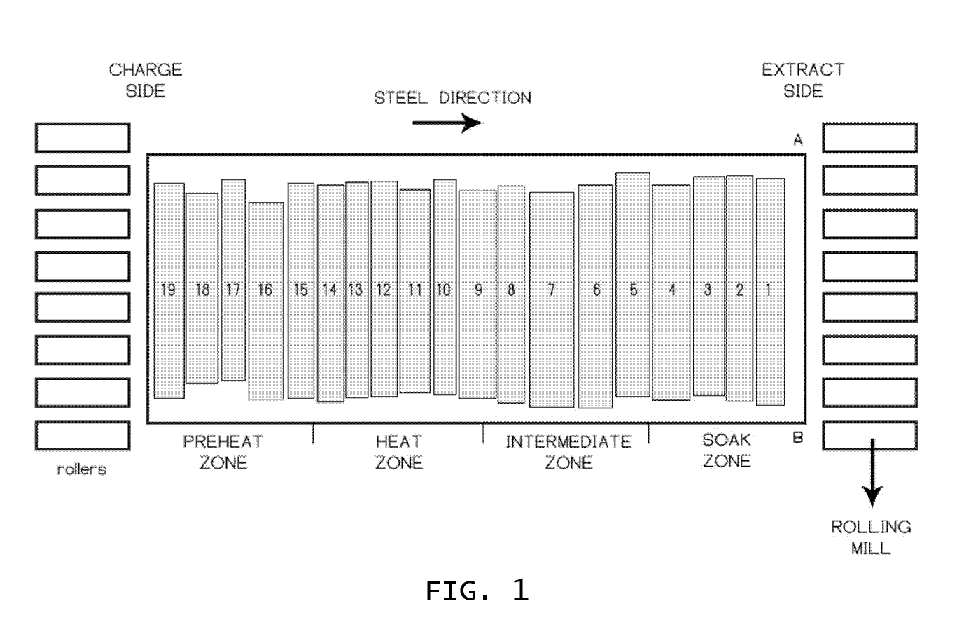

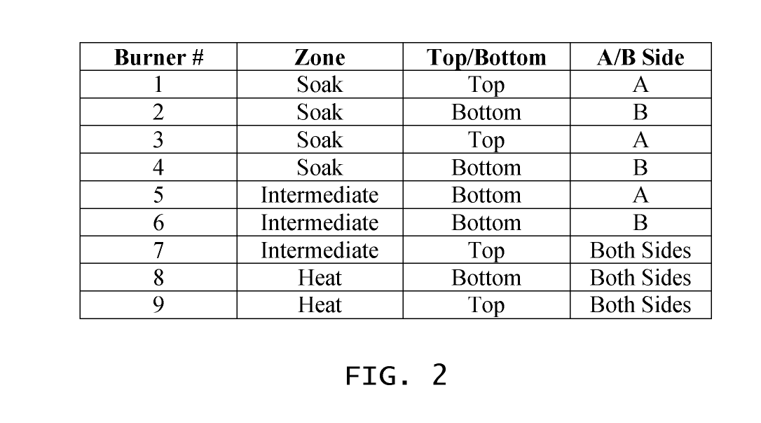

An example of a steel reheat furnace is shown in FIG. 1. The view is top down; slabs are charged at the left side, traverse rightward through the furnace, and are extracted at the right end, where they proceed on rollers to be milled. Such furnaces are divided into zones, in this case four zones, though the invention works with one or more zones in a reheat furnace. In this example, the Preheat zone contains no burners. The remaining zones are the Heat, Intermediate, and Soak zones. The example furnace has nine burners, which are distributed throughout the zones and are either top or bottom burners according to the table in FIG. 2. Burners 1, 3, 7, and 9 are top burners, and the others are bottom burners. Some of the burners are associated with an A or B side, but for purposes of this example, all directly opposing burners can be assumed to be controlled identically.

A primary function of the present system and method of furnace control is to provide temperature setpoints for each zone, and more specifically for each burner in each zone. Setpoints must be selected such that the slab is adequately heated throughout its thickness and has a sufficient temperature difference between the top and bottom sides to prevent the slab curling while being rolled. This must also be accomplished with minimum fuel use.

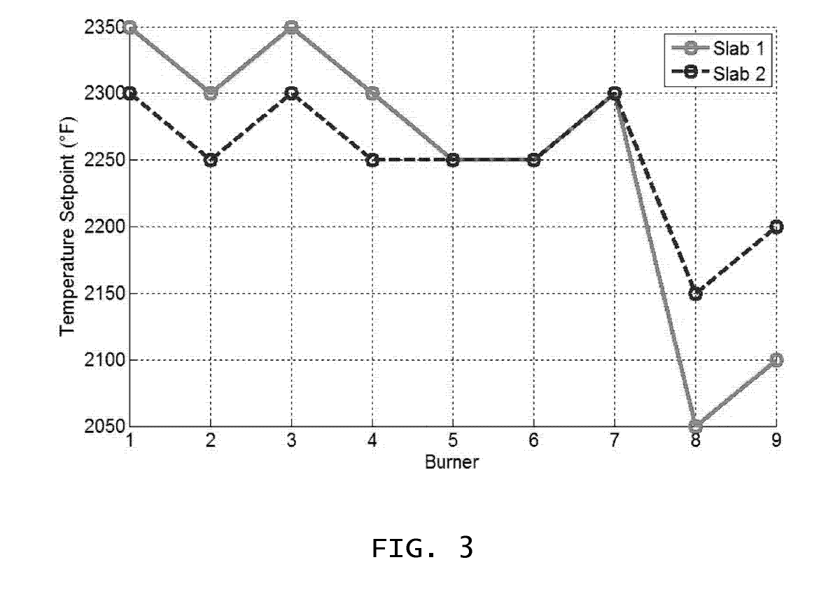

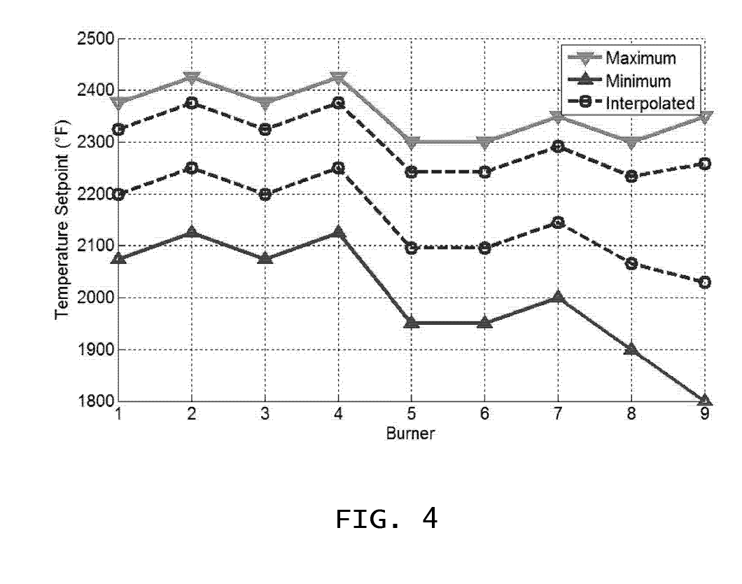

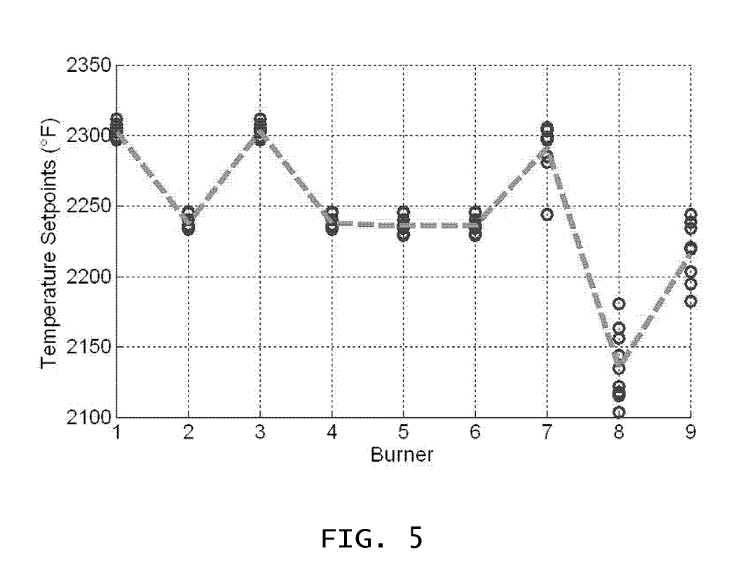

It is theoretically possible to optimize every setpoint individually for every slab that enters the furnace, but this leaves open the possibility that different slabs' optimal setpoints will conflict with each other. For example, if two slabs next to each other have optimal setpoints as shown in FIG. 3, selecting either setpoints for furnace control results in one of the slabs receiving setpoints substantially deviating from the calculated optimal ones. In order to remedy this, the invention utilizes preselected groups of setpoints as shown in FIG. 4. In the example, there are two setpoint groups, a minimum and a maximum; however, there can be more than two groups as long as the resulting lines do not intersect. The intermediate lines are examples of groups of setpoints resulting from interpolation of the two parent groups. To arrive at the setpoints, an interpolation variable P is defined, for example over the range of 2125 to 2425 which is the setpoint range for burner 1. A value of 2125 corresponds to the minimum allowable setpoints, and 2425 corresponds to the maximum setpoints. Every value in between is an interpolation of the two setpoint groups, or if there are more than two groups, of the two groups where the burner 1 setpoints are immediately above and below the value of P. Once P is selected, then for every burner, the setpoint Tᵢ is calculated from

$${T}_{i} = {T}_{min , i} + \frac{( P - {P}_{min} )}{} ( {P}_{max } - {P}_{min} ) * ( {T}_{max , i} - {T}_{min , i} )$$

where T_{min,i} and T_{max,i} are the minimum and maximum setpoints for burner i, respectively. Pₘᵢₙ [symbol] and Pₘₐₓ [symbol] are the minimum and maximum values of the interpolation variable.
Selection of the optimal setpoint groups from which actual setpoints will be derived is an optimization problem. One method of choosing a group is to optimize setpoints individually for a large number of slabs, then look at the resulting setpoint patterns and choose a reasonable average of the those setpoints for each burner. Such a process is illustrated in FIG. 5, where optimal setpoints for a number of slabs are shown along with the line representing the selected mean setpoints. Those mean setpoints might then form a parent setpoint group used for interpolation.

When optimizing individual setpoints, one must arrive at those setpoints which result in the desired slab heating properties listed above, as well as minimize fuel usage. The ability of a group of setpoints to heat the slab as desired can be ascertained by simulating the slab's residence in the furnace at the given setpoints with a heat model. A given slab will typically be provided with an approximate aim discharge temperature which is adequate for purposes of finding optimal setpoint groups. A more accurate aim discharge temperature is used when controlling the actual furnace as calculated by a temperature loss model (described below). This simulation will yield the slab's net temperature and temperature distribution which can be compared to that which is desired.

Correlating a group of temperature setpoints to fuel use, which is also required in the optimization, is difficult. In practice, even in steady state operation, any group of setpoints can potentially result in widely varying fuel use by the furnace depending on current operating conditions. For example, moderate to high setpoints can easily be obtained in an empty furnace without excessive fuel use. However, a furnace filled wall to wall with steel will consume much more fuel to maintain those same setpoints. Therefore, fuel use for given setpoints will always depend on the quantity and distribution of steel in the furnace, as well as the rate of extraction and other factors. However, it is safe to assume that a lower temperature setpoint for a given burner will always use less fuel than a higher one for that burner. Thus, the minimal temperature setpoints that result in the desired slab temperatures are sought in the optimization. Because burners are different sizes, however a higher setpoint in a zone with smaller burners (i.e. the Soak zone) usually requires less fuel than maintaining the same setpoint in the Heat zone which has larger burners, heats a larger area, and encounters the steel at its coolest temperature. A simple means of capturing the differing fuel use between burners of different sizes (and maximum fuel flow rates) is to weight the selected setpoints by burner size. A theoretical burner fuel use value for purposes of the optimization can be calculated as Fᵢ=Tᵢ*Bᵢ, where Bᵢ is burner size.

With these quantitative assessments of setpoint performance in place, setpoints for a large number of slabs can be optimized and condensed into setpoint groups as described above. Those groups then become subject to interpolation when selecting real setpoints for furnace control. The groups should be selected to be non-intersecting when plotted, i.e. such that if a burner setpoint in group A is higher than that burner's setpoint in group B, then for each other burner, the group A setpoint is also higher, and vice-versa if the A setpoint is lower.

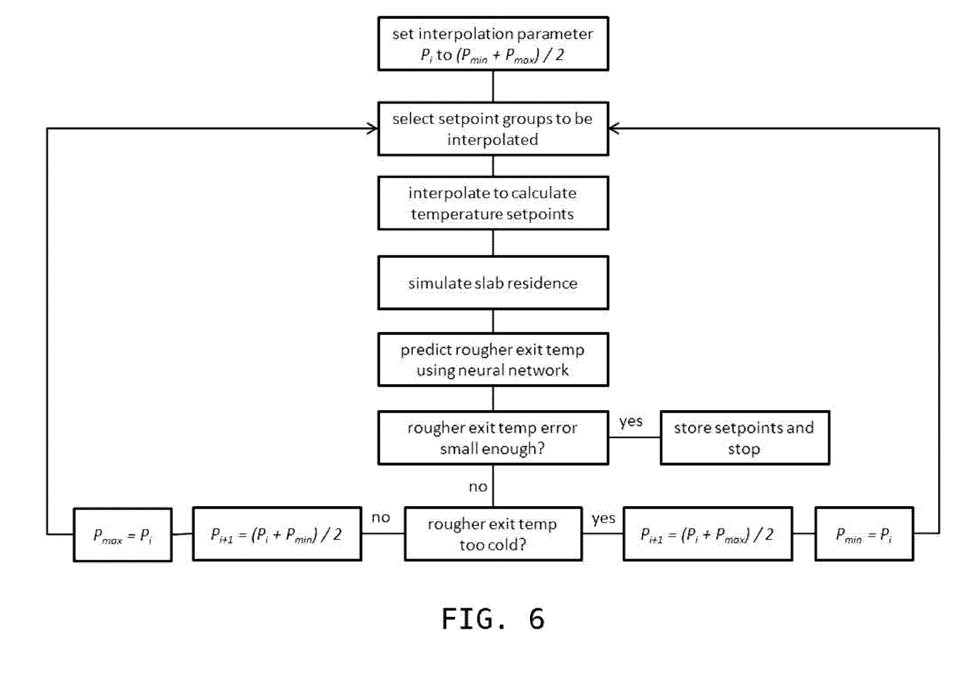

When a slab is charged into the furnace, a search is typically conducted for the minimal temperature setpoints which are predicted to heat the slab such as to yield the desired rougher exit temperature given the expected residence time which may be predefined for each slab type, and also may be impacted by the current production rate. Every candidate group of setpoints tested can be an interpolation as described above. Many types of searches can be performed, but a reasonably efficient method is a binary search for the ideal interpolation variable Pᵢ. A diagram of this process is shown in FIG. 6. The initial value of Pᵢ is chosen as the average between the minimum and maximum values of P. The real setpoints are calculated via interpolation, and the slab's residence in the furnace is simulated. After the simulation, the resulting slab temperature, as well as other selected information about the slab, which may include but is not limited to thickness, weight, and elemental composition, is fed into the temperature loss model which can be a neural network that has been trained on the actual temperature loss results of a large number of slabs. If the slab's predicted discharge temperature minus the predicted temperature loss is too low, the interpolation variable is updated to

$${P}_{i} = \frac{{P}_{i} + {P}_{max }}{2} ,$$

and Pₘᵢₙ [symbol] is updated to be the current Pᵢ. When the predicted temperature is too high, Pᵢ becomes

$$\frac{{P}_{i} + {P}_{min }}{2} ,$$

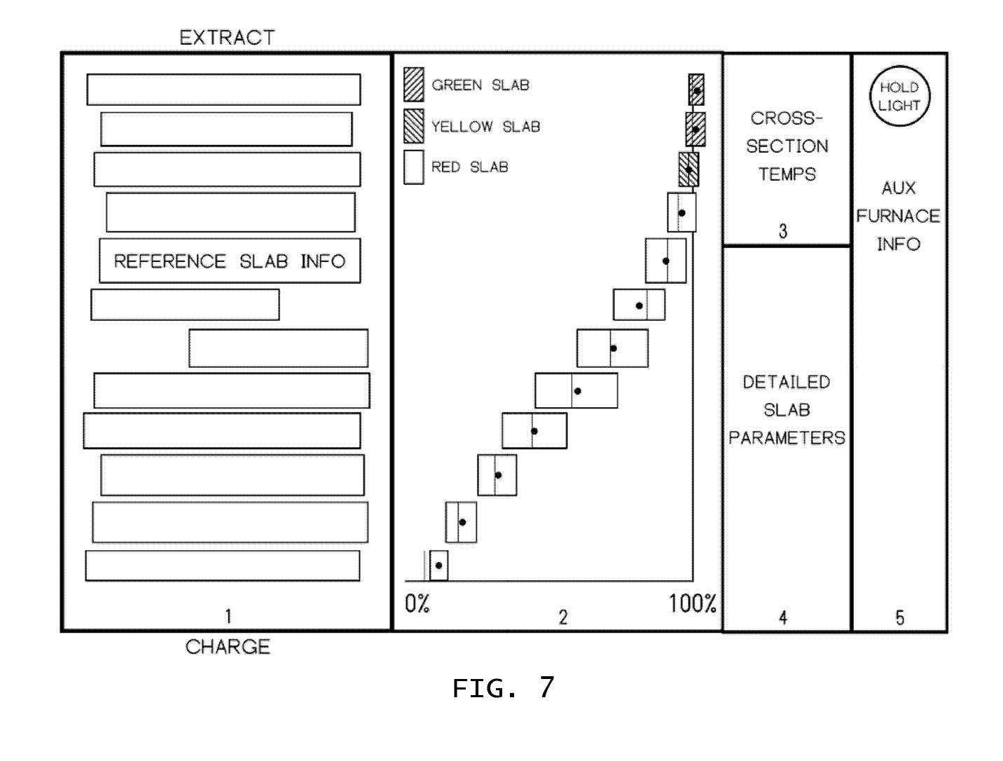

with Pₘₐₓ [symbol] then set to the current Pᵢ. If the error between the predicted and desired rougher exit temperature is sufficiently small, or the search iteration limit is reached, the search is halted. Although the example of a binary search is given here, any other type of search or optimization of an interpolation parameter is within the scope of the present invention. At the end of this search, the slab's calculated temperature history with respect to both time and position in the furnace is stored by the control system, as are the calculated setpoints, which are subsequently used for controlling furnace temperatures as described below. The slab temperature history data is used to display each slab's current expected temperature as a function of both how long it has been in the furnace and how deep it is into the furnace. This information is made available to furnace and mill operators via a furnace map an example of which is shown in FIG. 7. The short white lines on the relative readiness display of FIG. 7 represent the slab's current expected average temperature as calculated in the initial search process. The furnace map is described in greater detail below.

This search process for ideal temperature setpoints not only occurs for each slab when charged, but is repeated at configurable intervals and/or upon the occurrence of certain events such as a slab extraction, or the receipt of rougher exit temperatures for the last extracted slab. This gives the control system the opportunity to account for changes in extraction rate which affect the expected residence time of the remaining slabs and changes in the temperature loss model error which represents the current error between the actual temperature loss and that predicted by the temperature loss neural network. Because this error may change substantially by the time a newly charged slab reaches extraction, the error is not incorporated into the setpoint search for new slabs. For slabs nearing extraction, however, this error term should be added to the predicted temperature loss. Calculation of temperature loss model error is described further below. When new setpoints are calculated, the old setpoints for that slab are overwritten; however, the temperature history remains as originally calculated.

The slab temperature measurements are subject to error due to debris or slagging on the surface of the slab and other reasons. Thus, a feature of the present invention is to filter the temperature measurements and divide them into groups representing different segments of the slab. The resulting filtered temperatures, in addition to being used for feedback to the temperature loss model, can provide additional information about uneven heating conditions inside the furnace.

One way to filter the temperature measurements is to first divide the temperatures into segments covering the length of the slab. Then for each segment determine an average temperature. Temperature measurements for a segment falling too far above or below the average are discarded. A global minimum temperature can also be applied where any measurements below this value are discarded automatically.

The actual furnace setpoints are determined by considering each slab in a given zone, and combining the desired setpoints for the different slabs. In order to ensure that the slab with the highest required setpoint is heated sufficiently, the user may choose to simply select the highest setpoint for that zone or burner. However, fuel minimization is achieved by using tolerance bands and error bands to allow some slabs to be slightly under-heated. Fuel is saved by taking a weighted average of the different setpoints, where the weights are chosen such that the most demanding slabs will still fall within an acceptable temperature window.

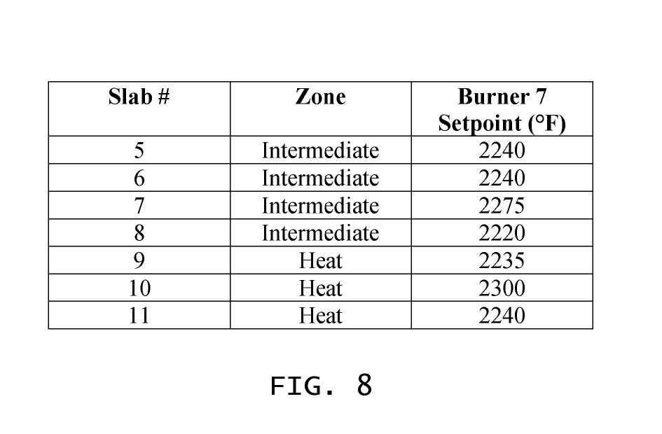

Another configurable option is how far in advance to begin accounting for higher setpoints required by slabs that are not yet in a given zone. If these slabs are not accounted for, the zone will only be able to achieve the desired setpoints after more demanding slabs enter the zone, if at all. If they are accounted for too early, fuel will be wasted heating the zone unnecessarily early. FIG. 8 shows a table where some potential setpoints for Burner 7 (the top burner in the Intermediate zone) for several slabs in the Intermediate and Heat zones of the example furnace shown in FIG. 1. If configured to choose the maximum zone setpoint, the control system would select 2275° F., which corresponds to slab 7. However, slab 10 requires a setpoint of 2300° F. Due to its proximity to the Intermediate zone, this should be taken into account. One method of achieving this is to blend the maximum setpoint of slabs in the zone, with that of slabs approaching the zone, depending on how close to the zone the approaching slab is. In this case, slab 10 is about 70% of the way from the Heat zone to the Intermediate zone, so the final setpoint could be 2275*0.3+2300*0.7≅2293.

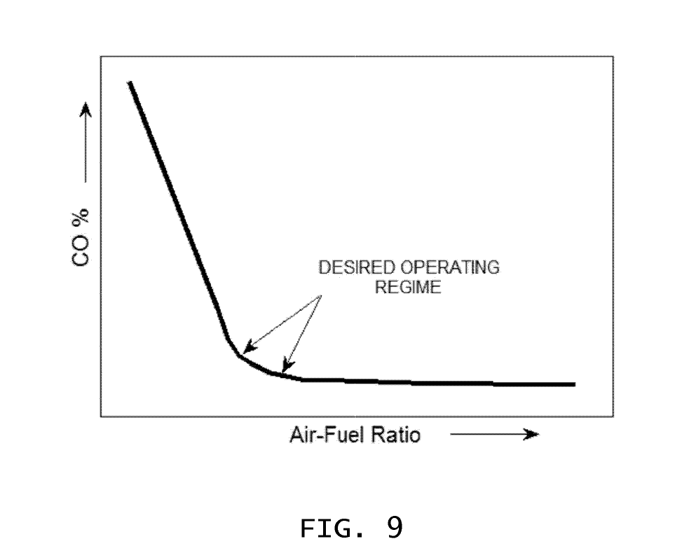

To minimize slagging, excess oxygen can be reduced to levels sufficient to combust the total fuel. The typical constraint is the level of CO, especially near the exit of the furnace before the gas exits up the stack. CO exhibits a non-linear response to oxygen deficiency rising rapidly if oxygen is reduced below the stoichiometric air to fuel ratio. See FIG. 9. The goal is to generate some CO without entering the region of rapid CO increase. This logic can be implemented in the graphical interface, but is simple enough to be placed into Programmable Logic Controller (PLC) logic. In conjunction with lower SP for the fuel minimization, slagging loss can be greatly reduced. Additionally, the air control logic can be tuned to respond to burner issues or temperature gradient problems with steel slabs measurement on exit. Based on the feedback of which sides of the furnace are running cool or hot, the system can add an air control bias to the burners where they oppose each other across the furnace. The air can be used to “push” temperature in the desired direction.

It was stated earlier that once slabs are sufficiently close to the extract area, in our example when they enter the Intermediate zone (though it may be any zone), the temperature loss model error should be accounted for in the recalculation of their needed setpoints. It is a feature of the current invention to track the temperature loss model error in such a way that it conservatively anticipates the subsequent error values. One simple scheme for doing so is to select separate weights for when the next measured error is higher or lower than the current filtered error value. For example, if the increasing error weight is 0.8, and the decreasing error weight is 0.4, then if the next error, eᵢ₊₁, is greater than or equal to the current filtered error, e_{f,i} than the new filtered error value is e_{f,i+1}=e_{f,i}*0.2+eᵢ₊₁*0.8. Otherwise, e_{f,i+1}=e_{f,i}*0.6+eᵢ₊₁*0.4. An example showing this calculation for several sequential error measurements is shown in FIG. 9. In this way, the user can configure the rate that the setpoint calculations respond to increases and decreases in the temperature loss model error.

A feature of a preferred embodiment is the graphical furnace map combined with relative readiness display, an example of which is shown in FIG. 7. It includes an error corrected estimate of slab temperatures, which provide a reasonable substitute for lack of actual slab temperature measurements in the furnace or models which do not correct for actual results post heating. It also gives a “relative readiness display,” which helps operators understand control systems adjustments and allows operators to tolerate lower temperature setpoints. This display can be web-enabled, and therefore can be accessed at multiple points throughout the facility.

On the left side of the furnace map is a portrayal of the slabs showing their relative sizes and positions in the furnace. Slabs are colored according to their calculated temperature, with colors selected to portray their visual appearance. Helpful information is displayed across each slab, and selecting a given slab via the user interface results in more information being displayed, including slab parameters and the cross-sectional temperature distribution, which appear to the right of the relative readiness display. On the top far right is displayed the current hold status, which is green under normal conditions, and red when the mill and furnaces are experiencing a production delay. Below that is information about the most recently extracted slab including the identification number, desired rougher exit temperature, and filtered measured rougher exit temperatures. Further below is the current filtered temperature loss model error (labeled at Temp Loss Bias in the example) followed by the pacing status which is the minimum seconds before the next-to-extract slab is predicted to be at an acceptable temperature. This value shows “Ready” if the slab has already achieved such a temperature. Finally, two calculated efficiency values are displayed for the furnace. Efficiency is defined as the estimated percent of the heat made available from combustion of the fuel that has been absorbed by the slabs in the furnace. The two efficiency values shown include one short term (in the example, 10 minute average), and one spanning the entire production run from when the first slab was extracted from the furnace.

The relative readiness display provides helpful feedback to mill and furnace personnel regarding the heating progress of slabs in the furnace, both with respect to slabs' anticipated temperature rise profiles, and with respect to their readiness to be extracted from the furnace. The primary characteristic of this feature is to spatially show the movement of slabs toward a 100% readiness state where their calculated temperature is expected to result in the desired rougher exit temperature. Although the implementation of this feature may vary, the present example includes short white lines that show the current expected temperature for each slab, and black dots that represent the current slab average temperature. The left and right edges of each slab, then correspond to the minimum and maximum temperatures within the slab, respectively. Thus, slab widths in the relative readiness display are expected to be wide when the rate of heating, and therefore the temperature gradients within the slab, are at maximum, and narrow when the heat has been evenly distributed through the slab. Slabs are then color coded according to their readiness for extraction. Green indicates a slab is expected to meet or exceed desired rougher exit temperature. Yellow slabs may be below rougher exit temperature, but still within acceptable limits. Red slabs, if extracted, are predicted to fall below acceptable limits. These limits may be configured in real time by the user using elements of the graphical displays.

The short white line representing the expected slab temperature represents the minimum of two points in the slab's anticipated temperature profile as initially calculated when the slab is charged into the furnace. The first is the maximum temperature the slab achieves at its current distance into the furnace. The second is the temperature the slab achieves at its current duration of time in the furnace. By including both points and taking the minimum, the expected temperature remains accurate even if slabs are moved rapidly through the furnace such as in the beginning of a production run, or if slabs are held for extra time at any point in the furnace due to pacing changes or production delays.

This embodiment includes special handling of production delays, also known as holds. When a hold occurs, an expected hold duration may be specified by furnace or mill operators, or generated automatically by the control system. If no hold duration is received, the method anticipates a short hold, and slabs in or near the extract area will continue to be heated until they are ready for discharge, i.e. they achieve green status in the relative readiness display. Temperatures are then lowered to maintain desired discharge temperature without overheating. Similar to the setpoints calculations described above, these temperatures are based on some combination of the desired slabs in the extraction area and those approaching it.

In the furnace zones closer to the charge side, when a hold without specified duration occurs, slabs are heated normally until they are at or above the expected temperature as indicated by the short white line in the relative readiness display. Once all slabs in a zone are at or above their expected temperature, zone temperatures are lowered substantially to create fuel savings and avoid maintaining unnecessarily high slab temperatures.

When an anticipated hold duration is provided by operators, and it is above a configurable time threshold, instead of continuing to heat slabs as before, temperatures in all zones will immediately begin decreasing from their current setpoint by a configurable curve and amount with no theoretical limit on the maximum temperature reduction. Then, throughout the hold duration, at intervals, the heat model uses simulation to estimate how long the slabs closest to being extracted will require to obtain their desired discharge temperature. If that time, plus a configurable margin, exceeds the remaining hold time as provided by operators, furnace temperatures will increase immediately so that slabs are prepared for extraction when the mill reenters production.

Another feature of the embodiment is the extraction readiness feedback function. This is displayed for mill and furnace operators in a furnace map (FIG. 7), under the label “Minimum seconds before extract.” This value is calculated by the heat model, which, using the current furnace temperatures in the extraction area, simulates the next-to-extract slab forward in time, and reports how much more heating time is required before this slab is predicted to have acceptable rougher exit temperature. If the slab is currently ready, the value displayed is “Ready.” This value, which is a number in seconds, is also fed directly into the extraction control system so that necessary delays can be implemented automatically without relying on operator intervention. If the current slab is ready to be extracted, the number outputted to mill control is zero.

Further graphical interfaces are provided to the user which allow for changes to the configuration via many control variables which govern, for example the blending of temperature setpoints for slabs in adjacent zones, behavior during production delays, preselected setpoint groups, slab temperature margins, and other aspects of control. These displays, and the program logic itself, are implemented in a graphical programming environment where the necessary tools for controlling logical flow, performing optimization, training and querying neural networks, data filtering, and more are prepackaged for the user. A capability of this environment is that changes can be applied in real time not only to configuration variables but to the control logic itself without interruption of control, due to the real-time refresh capability. See U.S. Pat. No. 9,058,029 for further details regarding the graphical programming environment.

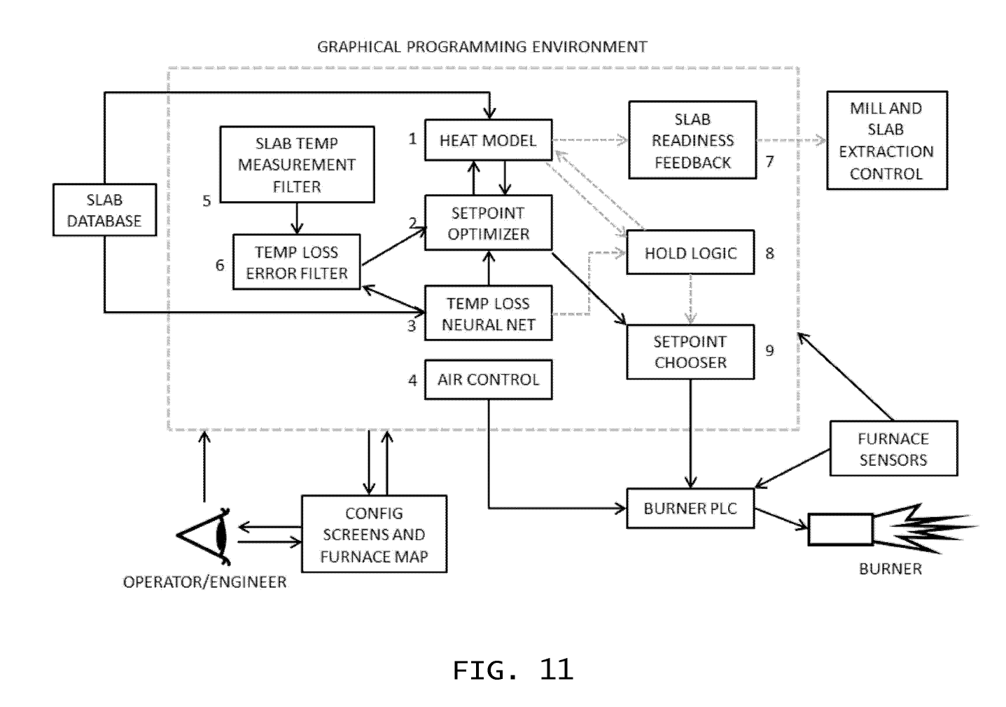

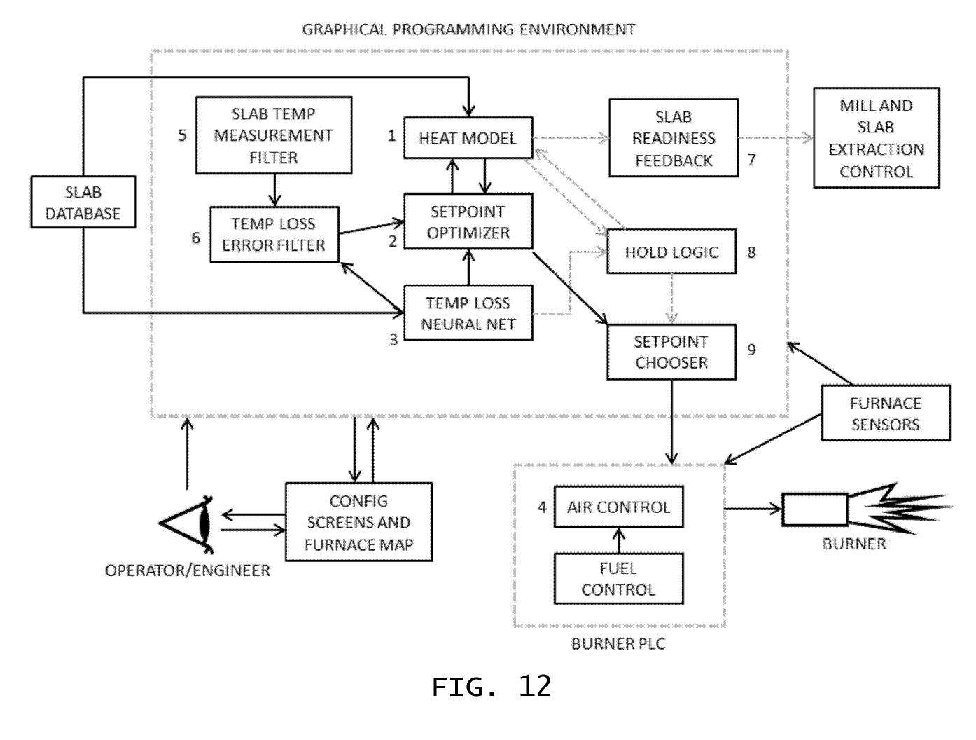

FIG. 11 shows how the several elements of the current embodiment interface together and exchange information. FIG. 12 shows an alternative assembly, where the air control element has been moved inside the burner PLC. The graphical programming environment is shown as separate from other elements of the system such as the operators and engineers, the mill and slab extraction control system, the furnace sensors, and the burner controllers. The slab database element represents the information provided to the system about each slab such as physical dimensions, weight, and aim rougher exit temperature.

For most elements, there are alternative approaches to implementation, the use of which would still be in keeping with the spirit of the present invention, which relates not only to specific implementations of some elements, but also to the assembly and coordination of all the elements in a furnace setpoint control system. For example, the hold logic (8) may, instead of reducing temperatures and waiting until the heat model advises raising them, may calculate a new slab residence time based on the expected hold time, and new optimal setpoints computed accordingly. The slab temperature measurement filter (5) and temperature loss error filter may utilize different logic and/or statistical methods. The setpoint optimizer (2) can also be based on a gradient method and an overall heat balance. Different methods of blending ideal slab setpoints based on slab furnace position can be used in the setpoint chooser (9). The temperature loss neural net (3) can alternatively be replaced with a rule based system or a neural network that directly calculates slab temperature based on the slab's time history in the furnace.

Arrows shown with dashed lines represent optional connections where elements could be removed without changing the fundamental operation of the furnace setpoint control system. The hold logic (8) does not apply during normal production, but only when a production delay is encountered. The slab readiness feedback element is also optional, since it only affects furnace and mill operation when a slab is expected to be rejected for low temperature, which should happen rarely under normal production conditions.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A method for controlling temperature setpoints for a steel reheat furnace with multiple zones that continuously passes a random mixture steel slabs with different compositions, sizes, initial temperatures, temperature requirements and residence times through said zones that are discharged at a predetermined desired temperature for each slab, comprising:
(a) selecting initial setpoints for each zone via an optimization process that minimizes fuel usage on a per ton of steel basis and provides a computed temperature distribution of discharged slabs at different temperature levels spanning a furnace operating range;
(b) subsequently interpolating said initial setpoints to determine optimal computed setpoints for each slab;
(c) setting the furnace with the computed setpoints;
(d) repeating steps (a) and (c) as slabs are inserted, move through the furnace and are discharged.

2. The method of claim 1 wherein a simulator includes error sources and calculates an unmeasured temperature for each slab in the furnace.

3. The method of claim 2 further comprising measuring actual surface temperature of a slab after discharge from the furnace and then filtering the measured surface temperature by discarding temperature values outside a predetermined band surrounding an average producing a filtered slab temperature.

4. The method of claim 3 wherein a neural network estimation function of temperature loss estimates a difference between the computed unmeasured slab temperature at discharge for a particular slab and a slab's actual temperature from a second temperature measured at a later point in a rolling process.

5. The method of claim 4 wherein the later point in the rolling process is after at least one rolling mill and at least one surface cleaning station.

6. The method of claim 4 wherein the filtered slab temperature is fed into the neural network.

7. The method of claim 6 wherein filtered slab temperatures are adjusted by combining the differences from several most recently discharged slabs.

8. The method of claim 1 adjusted to determine said temperature setpoints when a production delay is encountered and furnace temperatures are lowered using a simulation to predict when to increase furnace temperatures such that next discharged slabs are at a correct discharge temperature at a time when production is expected to recommence.

9. A closed-loop control system for determining and controlling temperature setpoints for a steel reheat furnace with multiple zones that continuously passes a random mixture steel slabs with different compositions, sizes, initial temperatures, temperature requirements and residence times through said zones that are discharged at a predetermined desired temperature for each slab, the control system comprising:
a neural network temperature loss model that includes an estimation function of temperature loss estimates a difference between the computed unmeasured slab temperature at discharge for a particular slab and a slab's actual temperature from a second temperature measured at a later point in a rolling process;
a thermal estimation model including a simulator computing error sources and calculating an unmeasured temperature for each slab in the furnace using filtered actual temperatures;
an optimization system for temperature setpoints based on the thermal estimation model that minimizes fuel usage on a per ton of steel basis.

10. The system of claim 9 further comprising a web-enabled operator interface displaying error-corrected values of slab temperatures, a current state of slab readiness with respect to desired discharge temperatures for each slab.

11. The system of claim 10 further comprising said web-enabled operator interface displaying furnace parameters and system operation parameters.

12. A method for controlling temperature setpoints for a steel reheat furnace with multiple zones that continuously passes a random mixture steel slabs with different compositions, sizes, initial temperatures, temperature requirements and residence times through said zones that are discharged at a predetermined desired temperature for each slab, comprising:
(a) selecting initial setpoints for each zone via an optimization process that minimizes fuel usage on a per ton of steel basis and provides a computed temperature distribution of discharged slabs at different temperature levels spanning a furnace operating range;
(b) subsequently interpolating said initial setpoints to determine optimal computed setpoints for each slab;
(c) setting the furnace with the computed setpoints;
(d) repeating steps (a) and (c) as slabs are inserted, move through the furnace and are discharged;
wherein a simulator includes error sources and calculates an unmeasured temperature for each slab in the furnace;
wherein measurement of actual surface temperature of a slab after discharge from the furnace is filtered by discarding temperature values outside a predetermined band surrounding an average, producing a filtered slab temperature.
wherein a neural network estimation function of temperature loss estimates a difference between the computed unmeasured slab temperature at discharge for a particular slab and a slab's actual temperature measured at a later point in a rolling process.

13. The method of claim 12 wherein filtered slab temperatures are adjusted by combining the differences from several most recently discharged slabs.

14. The method of claim 12 wherein the later point in the rolling process is after at least one rolling mill and at least one surface cleaning station.
